(19) United States
(12) Patent Application Publication
(10) Pub. No.: US 2007/0207311 A1
(43) Pub. Date: Sep. 6, 2007

(54) Double-Sided Adhesive Strip with a Higher Bearing Force

(75) Inventors: Wolfgang Klauck, Meerbusch (DE); Gaby Schilling, Duesseldorf (DE); Anke Lewin, Duesseldorf (DE); Stefan Kucken, Langenfeld (DE); Bjoern Davepon, Juechen (DE); Reinhold Domanski, Neuwied (DE)

Correspondence Address: HENKEL CORPORATION, THE TRIAD, SUITE 200, 2200 RENAISSANCE BLVD., GULPH MILLS, PA, 19406, US

(73) Assignee: Henkel Kommanditgesellschaft auf Aktien (Henkel KGaA), Duesseldorf (DE)

(21) Appl. No.: 11/747,434

(22) Filed: May 11, 2007

Related U.S. Application Data
(63) Continuation of application No. PCT/EP05/11829, filed on Nov. 4, 2005.

(30) Foreign Application Priority Data
Nov. 12, 2004 (DE) 10 2004 054 846.3

(51) Int. Cl. B32B 3/26; B32B 7/12

(52) U.S. Cl. 428/354; 428/343; 428/344; 428/304.4; 428/317.1

(57) ABSTRACT

Two-sided adhesive strips for detachable bonding without residue or damage. The strips include a foam backing fixed to at least one essentially non-elastic layer. The bond is detached by rotative or shear force breaking the foam backing in two parts that remain attached to the bonded surfaces. The residues are removable by pulling at an angle greater than 45° from the bond plane. The strips have high load capacity and bearing strength.

### CROSS REFERENCE TO RELATED APPLICATIONS

This application is a continuation under 35 U.S.C. § 365(c) and 35 U.S.C. § 120 of international application PCT/EP2005/011829, filed on Nov. 4, 2005. This application also claims priority under 35 U.S.C. § 119 of DE 10 2004 054 846.3, filed Nov. 12, 2004, which is incorporated herein by reference in its entirety.

### BACKGROUND OF THE INVENTION

The invention relates to a double-sided adhesive strip for bonds, which can be detached again without residue or damage, and to its use.

DE 197 20 145 describes a double-sided adhesive tape with an intermediate backing and pressure-sensitive adhesive compositions coated on both sides of the intermediate backing, wherein the intermediate backing cleaves under the action of torsional forces, leverage forces and/or peel forces, and can then be detached without residue or damage by stretching in the direction of the bond plane. A disadvantage here is that an elastic backing material is needed to ensure the claimed removal mechanism and this consequently entails losses in the bearing strength of the adhesive tape.

Accordingly, the object of the present invention consists in the provision of a double-sided adhesive strip that has a high load capacity and bearing strength, but nevertheless can be easily detached again from the surfaces to be bonded.

It was surprisingly found that a double-sided adhesive strip with a backing and at least one layer of a material of low elasticity can solve the problems known from the prior art.

### DESCRIPTION OF THE INVENTION

Accordingly, the subject matter of the present invention is a double-sided adhesive strip coated with a pressure-sensitive adhesive, said strip comprising a backing with a first and a second surface for bonding two objects, wherein one of the surfaces of the backing is fixedly connected to a layer A that under conditions of application is essentially non-elastic and the other, opposite surface is fixedly connected with a layer B and both the exterior sides of layers A and B are coated with a pressure-sensitive adhesive, wherein the adhesive strip can be split in the backing into two parts by the action of rotative or shear forces, said parts remaining bonded to both the bonded objects and being removable from the respective bonded objects by being pulled at an angle of greater than 45° with respect to the surface of the bonded object.

In the context of the present application, the term “under conditions of application is essentially non-elastic” means that the force required to remove the remaining adhesive strip from an object by hand is so low that it causes the layer A (or B) to elongate by less than 5% based on its initial length. This is fulfilled for example, by a biaxially oriented 50 μm thick and 2 cm wide PET film that elongates less than 5% in length under a pulling force of 5 kg.

The bond between the backing and the layers A and B can be achieved, for example, by adhesion. It is also in the scope of the invention that a pressure-sensitive adhesive compound can form the layer B. In this case the layer B and the pressure-sensitive adhesive layer applied on the side of B form one entity, i.e. the pressure-sensitive adhesive compound is layer B and the pressure-sensitive adhesive at one and the same time.

The particular advantage of the inventive adhesive strip resides in the fact that the adhesives used do not have to be adapted to the mechanism of a stretching removal, i.e. by pulling at an angle approximately parallel to the bonding plane, with the result that a wider choice of pressure-sensitive adhesives is available for the inventive adhesive strip. Consequently, systems with a higher bearing force can be manufactured.

A further advantage is based on the fact that the almost negligible elasticity of the adhesive strip allows the user to effect a stripping movement for the removal. In contrast to a pulling removal movement, as is demanded from the user by elastic adhesive strips, damage to the surface of the remaining strip by a stripping removal is more unlikely. Moreover, the danger of an adhesive break, i.e. the remains of residues of adhesive on the object surface after removal of the remaining adhesive strip is reduced when removed by stripping. At the same time, this means that adhesives with a higher adhesion to the object can be employed than would be possible for a product to be pulled off.

To guarantee the functionality of the invention, it is required that the adhesion of the adhesive to the layers A and B be greater than the adhesion of the adhesive to the surfaces of the objects being bonded.

According to a preferred embodiment of the inventive adhesive strip, the layer B is characterized in that it essentially cannot be elongated under the conditions of use. In this respect, the material of the layers A and B can be the same or different. This is particularly advantageous, because for a double-sided finishing of the backing with strips of low elasticity, the adhesive residues, after the backing has been split, can be detached in a similar manner with little effort.

According to a further preferred embodiment of the inventive adhesive strip, the layers A and/or B consist of a material selected from polyester, polyamide, polyethylene, polypropylene, polyurethane. It is particularly advantageous when the layers A and B are manufactured from films of the above cited polymers. It is particularly advantageous here to employ films with a thickness below 50 μm, preferably below 30 μm, quite particularly preferably below 20 μm. Films of 20 μm thickness, particularly polyester films (PET), are particularly preferred, as films of this thickness guarantee an adequate tensile strength of the adhesive strip and low elasticity; on the other hand, however, the adaptability of the adhesive strip to slightly uneven backgrounds, such as, for example, an ingrain wall covering, is not greatly impaired.

According to a particularly preferred embodiment of the inventive adhesive strip, the layers A and/or B consist of mono- or biaxially oriented film. This is particularly advantageous, as such types of pre-treated films have a lower extensibility and higher elongation at break than untreated films of the same thickness. When using monoaxially oriented films, they are preferably mounted on the backing in such a way that the oriented direction runs parallel to the longitudinal axis of the adhesive strip. This ensures that a sufficiently low elasticity is achieved by the use of such anisotropic films in the machine direction.

According to a further preferred embodiment of the inventive adhesive strip, the layers A and/or B consist of woven or non-woven fiber material or a metal film, preferably an aluminum film. This is particularly advantageous, as on the one hand a sufficient tensile strength and low elasticity can be achieved by the use of fibers, and on the other hand, the adaptability to rough backgrounds is improved. The fibrous material includes, for example glass fibers, Kevlar®, polyamide-, polyester-, polyethylene-, polypropylene- or polyurethane fibers. These fibers can be either incorporated in a film or are directly embedded in the adhesive. When embedded in the adhesive, the layers A and B and the adhesive layers of the adhesive strip thus form a single unit.

According to a further preferred embodiment of the inventive adhesive strip, the adhesion between the layers A and the backing and B and the backing is greater than the adhesion of the adhesive to the surfaces of the objects bonded together. This is particularly advantageous, because in this manner it is ensured that a delamination of the layers A or B from the remainder of the backing is not possible during the removal process.

According to a further preferred embodiment of the inventive adhesive strip, the thickness of the backing is between 50 μm and 5 mm.

According to a further particularly preferred embodiment of the inventive adhesive strip, the backing is a polyethylene foam backing. This is advantageous, as the use of foamed backings enables an adequate adaptability of the adhesive strip to rough surfaces, such as, for example an ingrain wall covering, and moreover with an adequate strength. Foamed polyethylene backings are particularly preferred here, because due to the great number of commercially available foamed polyethylene backings, adhesive strips can be manufactured both for very rough surfaces, for which foamed polyethylene backings with a lower hardness are used, as well as adhesive strips with very high bearing strength or shear stress resistance by the use of very hard foams.

According to a particularly preferred embodiment of the inventive adhesive strip, the backing comprises a polyethylene foam backing that has a film on one or both sides. This is particularly advantageous because due to the film(s) on the foamed polyethylene backing, the tear strength of the adhesive strip and therefore the total bearing strength can be further increased.

According to a further preferred embodiment of the inventive adhesive strip, the bearing force is above 0.15 kg/cm² particularly above 0.2 kg/cm² for a shear force loading at an angle below 10°.

According to a particularly preferred embodiment of the inventive adhesive strip, the pressure-sensitive adhesive is an acrylate adhesive.

According to a further preferred embodiment of the inventive adhesive strip, the adhesive strip does not have a grip tab. This is particularly advantageous, because due to the inventive construction of the adhesive strip, the adhesive strip residues, after the background has been split, can be removed even without a grip tab, and therefore, space does not have to be wasted in order to conceal a grip tab under the object, particularly behind small objects to be glued, such as for example hooks that have to bear a high load. Moreover a projection of the grip tab would be aesthetically unfavorable.

A further subject matter of the present invention is a removable, self-adhering hook or similar fastening device with a base plate, wherein the base plate that is on the side opposite to the hook is furnished with the inventive adhesive strip. This is particularly advantageous, because in this way a hook can be directly furnished with the inventive adhesive strip with the result that advantageously, the greatest possible part of the base plate is covered with the inventive adhesive strip. The inventive adhesive strip can be stamped out to match any imaginable shape of a base plate of a hook or similar fastening device.

A further subject matter of the present invention is the use of the inventive adhesive strip for removably bonding two objects, wherein to loosen the bond, the backing is split into two parts by the action of rotative and shear forces and then the remaining residues of the adhesive strips on both objects are detached by pulling and/or peeling at an angle greater than 45°.

According to a preferred embodiment of the use of the inventive adhesive strip, one of the two objects to be bonded together is a hook or similar fastening device.

### DETAILED DESCRIPTION OF THE DRAWINGS

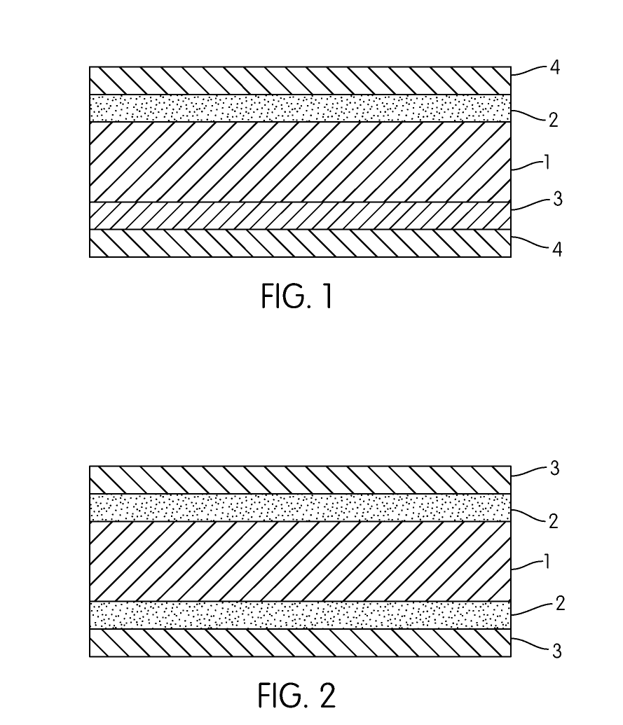

FIG. 1 shows an adhesive strip with the following construction: Layer 1 foamed polyethylene backing with a film of polyethylene (3), a polyester film (2) and two layers of a pressure-sensitive adhesive (4).

FIG. 2 shows an adhesive strip with the following construction: Layer 1 foamed polyethylene backing with two polyester films (2) and two layers of a pressure-sensitive adhesive (3).

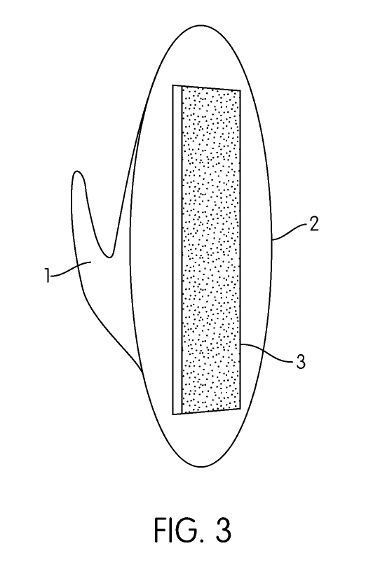

FIG. 3 shows a hook (1) with a base plate (2) and the inventive adhesive strip (3).

As used herein, and in particular as used herein to define the elements of the claims that follow, the articles “a” and “an” are synonymous and used interchangeably with “at least one” or “one or more,” disclosing or including both the singular and the plural, unless specifically defined otherwise. Words or phrases forming terms conjoined by “or” disclose or include each term alone as well as any combination of terms so conjoined, unless specifically defined otherwise.

What is claimed is:

1. An adhesive strip for bonding two objects that is coated on both sides with a pressure-sensitive adhesive, said strip comprising a backing with a first and second surface, wherein:
(a) one of the backing surfaces is fixedly connected to a layer A that under conditions of application is essentially non-elastic;
(b) and the other, opposite facing backing surface is fixedly connected with a layer B; and
(c) both the exterior sides of layers A and B are coated with a pressure-sensitive adhesive,
wherein after the exterior sides of layers A and B have been bonded to an object, the strip can be split in the backing into two parts by rotative or shear forces, said parts remaining bonded to their respective object and being removable from the object by pulling at an angle of greater than 45° with respect to the bonded surface of the object.

2. The adhesive strip of claim 1, wherein the layer B under conditions of application is essentially non-elastic, and the layers A and B can be the same or different.

3. The adhesive strip of claim 1, wherein the layers A and/or B comprise polyester, polyamide, polyethylene, polypropylene, or polyurethane.

4. The adhesive strip of claim 3, wherein the layers A and/or B comprise a mono- or biaxially oriented film.

5. The adhesive strip of claim 1, wherein the layers A and/or B comprise a woven or non-woven fiber material or a metal film.

6. The adhesive strip of claim 5, wherein the metal film comprises aluminum.

7. The adhesive strip of claim 1, wherein layer A and layer B are more strongly bonded to the backing than to the bonded objects.

8. The adhesive strip of claim 1, wherein the backing has a thickness between 50 μm and 5 mm.

9. The adhesive strip of claim 1, wherein the backing comprises a foam backing.

10. The adhesive strip of claim 9, wherein the foam backing comprises polyethylene.

11. The adhesive strip of claim 10, wherein the foam backing has a film on one or both sides.

12. The adhesive strip of claim 1, having a bearing force above 0.15 kg/cm² for a shear force loading at an angle below 10°.

13. The adhesive strip of claim 12, having a bearing force above 0.2 kg/cm² for a shear force heading at an angle below 10°.

14. The adhesive strip of claim 1, wherein the pressure-sensitive adhesive comprises a acrylate.

15. The adhesive strip of claim 1, having no grip tab.

16. A removable, self-adhering fastening device with a base plate, wherein one side of the adhesive strip according to claim 1 is bonded to the base plate.

17. A method of removably bonding two objects, comprising the steps of bonding two objects with an adhesive strip according to claim 1, loosening the bond by rotative or shear force so the backing is split into two parts each remaining attached to one of the two objects, and pulling and/or peeling each remaining part from its respective object at an angle greater than 45° to the object surface.

18. The method of claim 17, wherein one of the objects to be bonded together is a hook or similar fastening device.

19. An adhesive strip for bonding two objects that is coated on both sides with a pressure-sensitive adhesive, said strip comprising a backing with a first and second surface, wherein:
(a) one of the backing surfaces is fixedly connected to a layer A that under conditions of application is essentially non-elastic;
(b) and the other, opposite facing backing surface is fixedly connected with a layer B; and
(c) both the exterior sides of layers A and B are coated with a pressure-sensitive adhesive,
wherein after the exterior sides of layers A and B have been bonded to an object, the strip can be split in the backing into two parts by rotative or shear forces, said parts remaining bonded to their respective object and being removable from the object by pulling at an angle of greater than 45° with respect to the bonded surface of the object,
wherein the backing comprises a foam comprising polyethylene, wherein the layers A and/or B comprise a mono- or biaxially oriented film comprising polyester, polyamide, polyethylene, polypropylene, or polyurethane, and wherein the pressure-sensitive adhesive comprises acrylate.
